(19) United States
(12) Patent Application Publication
(10) Pub. No.: US 2016/0217705 A1
(43) Pub. Date: Jul. 28, 2016

(54) FOREIGN LANGUAGE TRAINING DEVICE

(71) Applicant: Mikaela K. Gilbert, Noblesville, IN (US)

(72) Inventors: Mikaela K. Gilbert, Noblesville, IN (US); Donald A. Wettrick, Greenwood, IN (US)

(21) Appl. No.: 15/006,470

(22) Filed: Jan. 26, 2016

Related U.S. Application Data
(60) Provisional application No. 62/108,206, filed on Jan. 27, 2015.

(51) Int. Cl. G09B 19/06; G09B 5/04

(52) U.S. Cl. CPC G09B 19/06; G09B 5/04

(57) ABSTRACT

A foreign language training device includes an egg-shaped outer shell having an outer surface with visual indicia representative of a foreign language stored in a memory. A motion sensor is configured to detect movement of the outer shell, wherein detected movement results in an audible output of a word phrase in both a native language and a foreign language.

### CROSS-REFERENCE TO RELATED APPLICATION

This application claims priority to Provisional Patent Application Ser. No. 62/108,206, filed Jan. 27, 2015, the disclosure of which is expressly incorporated herein by reference.

### BACKGROUND AND SUMMARY OF THE DISCLOSURE

The present invention relates to a language training device and, more particularly, to a bilingual educational toy to facilitate teaching foreign languages to children.

It is desired to provide an educational device for teaching children a second (foreign) language in addition to their native (first or primary) language. Such a device would make exposure to a language fun and accessible, thereby sparking interest in learning a foreign language at a young age. These objectives may be accomplished by providing the device with visual indicia associated with the foreign language, and with an interactive means to generate word phrases in both native and foreign languages.

According to an illustrative embodiment of the present disclosure, a language training device includes an egg shaped outer shell defining an internal chamber. The outer shell includes a base and an upper portion extending upwardly from the base. The base includes a semi-spherical outer surface. A weight is supported within the base for maintaining the outer shell in an upright position. A controller is supported within the internal chamber. A memory is supported within the internal chamber is operably coupled to the controller. The memory is configured to store a first phrase in both a native language and a foreign language. A speaker is supported within the internal chamber and is operably coupled to the controller. A user interface is operably coupled to the controller and is configured to transmit an audio output from the speaker in response to a user input. A power source is supported within the internal chamber and is operably coupled to the controller. The outer surface of the outer shell includes visual indicia representative of the foreign language stored in memory.

According to another illustrative embodiment of the present disclosure, a language training device includes an egg-shaped outer shell defining an internal chamber. The outer shell includes a base and upper portion extending upwardly from the base. The base includes a semi-spherical outer surface. A weight is supported within the base for maintaining the outer shell in an upright position. A controller is supported within the internal chamber. A memory is supported within the internal chamber is operably coupled to the controller. The memory is configured to store a first phrase in both a native language and a foreign language. A speaker is supported within the internal chamber and is operably coupled to the controller. A motion sensor is operably coupled to the controller and is configured to cause a controller to transmit audio output from the speaker in response to movement of the outer shell. A power source is supported within the internal chamber and is operably coupled to the controller.

According to a further illustrative embodiment of the present disclosure, a method of teaching a foreign language includes the step of providing an egg-shaped outer shell defining an internal chamber, and including a base and an upper portion extending upwardly from the base, the base having a semi-spherical outer surface. The method further includes the steps of rocking the outer shell about the base, transmitting an audible phrase in a foreign language, and transmitting the audible phrase in a native language.

Additional features and advantages of the present invention will become apparent to those skilled in the art upon consideration of the following detailed description of the illustrative embodiment exemplifying the best mode of carrying out the invention as presently perceived.

### BRIEF DESCRIPTION OF THE DRAWINGS

The detailed description of the drawings particularly refers to the accompanying figures in which:

FIG. 1 is a perspective view of an illustrative language training device of the present disclosure;

FIG. 2 is a partially exploded perspective view of the language training device of FIG. 1;

FIG. 3 is an exploded perspective view of the outer shell of the language training device;

FIG. 4 is a lateral cross-sectional view of the language training device, showing the base and internal components;

FIG. 5 is a longitudinal cross-sectional view, in partial schematic, of the language training device;

FIG. 6 is a block diagram of internal components of the language training device; and

FIG. 7 is a flow chart of an illustrative method of operation of the language training device of FIG. 1.

### DETAILED DESCRIPTION OF THE DRAWINGS

The embodiments of the invention described herein are not intended to be exhaustive or to limit the invention to precise forms disclosed. Rather, the embodiments selected for description have been chosen to enable one skilled in the art to practice the invention.

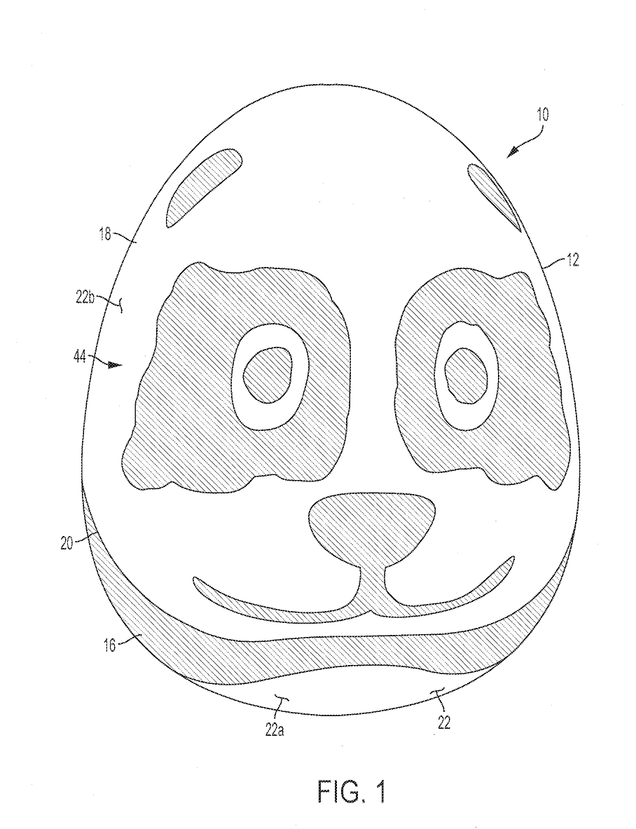

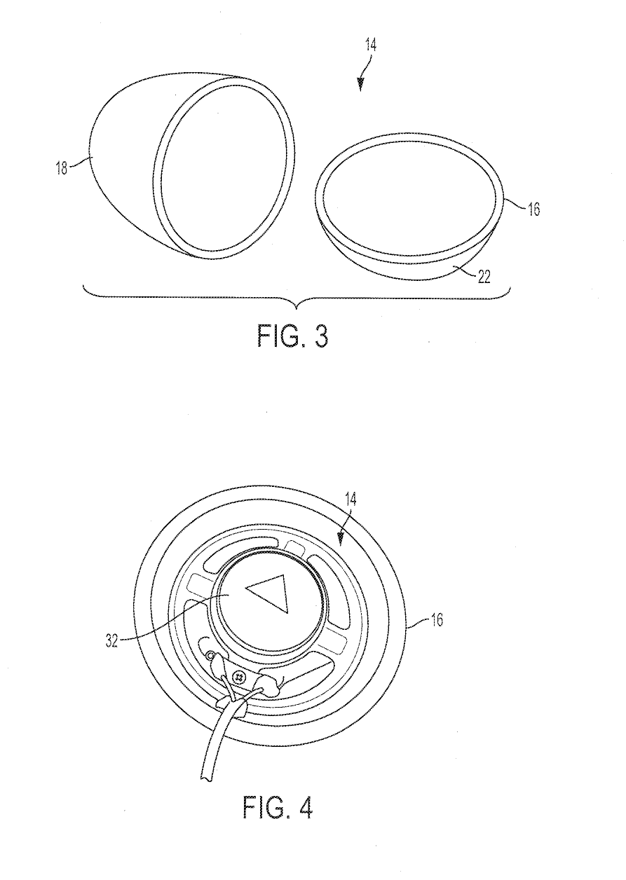

Referring initially to FIGS. 1-5, an illustrative foreign language training device 10 of the present disclosure includes an egg-shaped (i.e., ovoid shaped) outer shell 12 defining an internal chamber 14. The outer shell 12 may be formed of a polymer, such as a molded thermoplastic. The outer shell 12 illustratively includes a base 16 and an upper portion 18 extending upwardly from the base 16. The base 16 and the upper portion 18 may be coupled together at an interface 20 via conventional means, such as a cooperating threads, adhesives, or ultrasonic welding. Illustratively, the outer shell 12 includes an outer surface 22, wherein the outer surface 22a of the base 16 is generally semi-spherical, and more particularly the shape of a spherical ellipsoid, and the outer surface 22b of the upper portion 18 is generally the shape of a prolate spheroid.

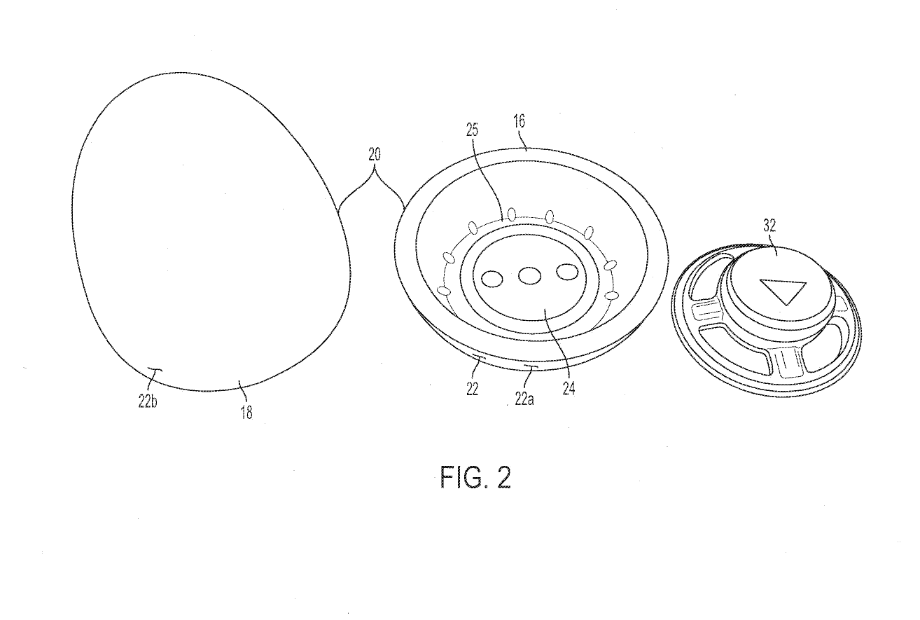

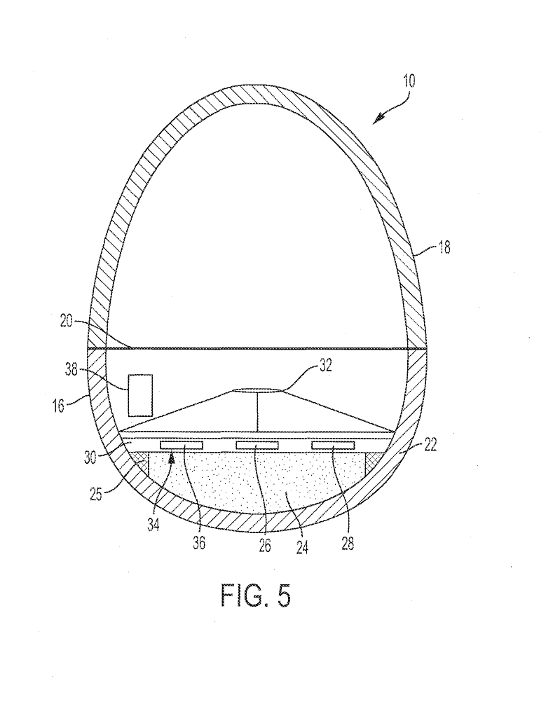

With reference to FIGS. 2 and 5, a weight 24 is illustratively supported within the base 16 for maintaining the outer shell 12 in an upright position. The weight 24 may be formed from any conventional material, such as a metal or contained sand. The weight 24 may be secured within the base 16 via conventional means, such as an epoxy 25.

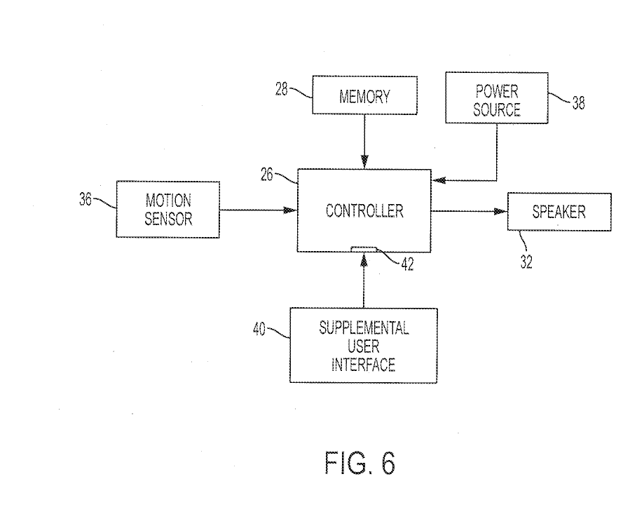

As shown in FIGS. 5 and 6, a controller 26 is illustratively supported within the internal chamber 14 of the outer shell 12 above the weight 24. A memory 28 is illustratively coupled to the controller 26 within the internal chamber 14. In one illustrative embodiment, the controller 26 and the memory 28 may be supported on a printed circuit board (PCB) 30. Illustratively, the PCB 30 is secured above the weight 24 via conventional means, such as an epoxy. As further detailed herein, the memory 28 is illustratively configured to store at least one word phrase in both a first or native language and a second or foreign language. In certain illustrative embodiments, multiple associated word phrases in both native and foreign languages may be stored in the memory 28. In one illustrative embodiment, eight (8) different word phrases are stored in memory 28. Illustratively, the native language comprises English, while the foreign language comprises at least one of Arabic, Chinese, French, German, Portuguese and Spanish. It should be appreciated that the number of different word phrases may vary. Additionally, the designated native language and foreign language may vary. Further, more than one foreign language may be associated with each native language word phrase.

Illustratively, an audio output device or speaker 32 is supported within the internal chamber 14 and is operably coupled to the controller 26. With reference to FIG. 5, a user interface 34 is illustratively configured to cause a controller 26 to transmit audio output from the speaker 32 in response to a user input. Illustratively, the user input is provided through the user interface 34 which illustratively comprises a motion sensor 36, such as a gravity switch, received within the internal chamber 14 of the outer shell 12. As such, rocking movement of the outer shell 12 activates the switch 36.

As detailed above, the controller 26, the memory 28 and/or the user interface 34 may be received within the internal chamber 14 of the outer shell 12. Alternatively, the controller 26, the memory 28 and/or the user interface 34 may be external to the outer shell 12. For example, the user interface 34 may be a handheld remote coupled (either through a wired or wireless electrical connection) to the PCB 30 (including the controller 26 and the memory 28) within the internal chamber 14 of the outer shell 12. Further illustratively, the user interface may be a handheld remote (including the controller 26 and the memory 28) coupled (either through a wired or wireless electrical connection) to the speaker 32 within the internal chamber 14 of the outer shell 12.

With reference to FIGS. 5 and 6, a power source 38 is illustratively supported within the internal chamber 14 and is operably coupled to the controller 26. Illustratively, the power source 38 comprises a conventional battery supported by the PCB 30. Alternatively, the power source may be external to the outer shell 12 and electrically coupled to the controller 26 by a cable or wire (not shown).

A supplemental user interface 40 may be provided in electrical communication with the controller 26. The supplemental user interface 40 may include at least one button allowing the user to change settings stored in the memory 28. The supplemental user interface 40 may by supported on the outer shell 12 and covered by a door or access panel (not shown). Alternatively, the supplemental user interface 40 may be a remote unit coupled through a wire (e.g., a plug received within an external port, such as a USB port 42 (FIG. 6)), or wirelessly to the PCB 30. In one illustrative embodiment, the user interface 40 may download additional word phrases to the memory 28 of the device 10.

The outer surface 22 of the outer shell 12 illustratively includes visual indicia 44 representative of the foreign language of the phrase(s) stored in the memory 28. Illustratively, the visual indicia 44 comprises an animal associated with the foreign language. Representative foreign languages and associated visual indicia 44 may include:

| Foreign Language | Representative Visual Indicia |
|---|---|
| Arabic | Elephant |
| Chinese | Panda |
| French | Rooster |
| German | Pig |
| Portuguese | Tree Frog |
| Spanish | Chihuahua |

While animals are the representative visual indicia 44, others may be substituted therefor. For example, representative visual indicia 44 may include flags, maps, landmarks, etc. that a person may associate with the country or geographic region of the foreign language.

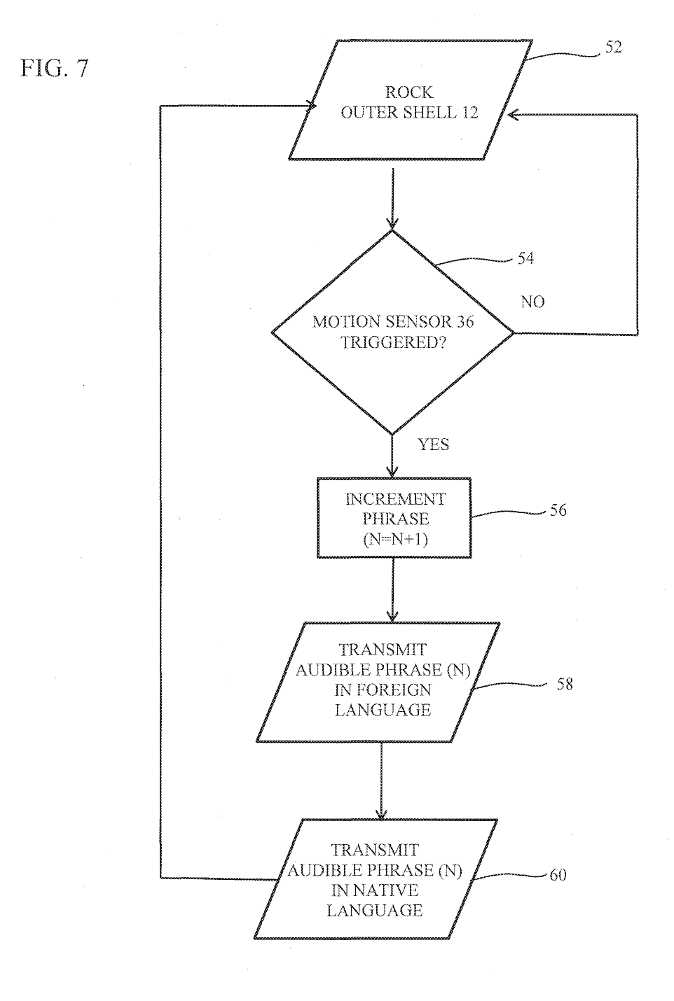

With reference now to FIG. 7, an illustrative method of operation of the foreign language training device 10 will be described. At block 52, a user pushes the upper portion 18 of the outer shell 12 to cause it to wobble or rock about its base 16. If such motion at decision block 54 is not sufficient to trigger the motion sensor 36, then the method returns to block 52 and the device 10 waits for further input. If such input rocking motion is sufficient to trigger the motion sensor 36, then the method continues to block 56 where the controller increments the word phrase stored in memory by one. Next, the controller 26 at block 58 generates an audio output through the speaker 32 of the word phrase stored in memory 28. Initially, the word phrase is transmitted in a foreign language (e.g., Chinese) at block 58, followed by the same audible word phrase in a native language (e.g., English) at block 60. The method then returns to block 52 and waits for additional input.

Subsequent user input causing the outer shell 12 to wobble or rock about its base 16 illustratively causes the controller 26 to produce audio output through the speaker 32 of additional word phrases stored in memory 28, first in the foreign language, followed by the same audible word phrase in the native language. More particularly, the word phrases stored in memory are incremented at block 56 by each subsequent input at block 52 that triggers the motion sensor 36 at block 54.

Although the invention has been described in detail with reference to certain preferred embodiments, variations and modifications exist within the spirit and scope of the invention as described and defined in the following claims.

1. A language training device comprising:
an egg-shaped outer shell defining an internal chamber, and including a base and an upper portion extending upwardly from the base, the base having a semi-spherical outer surface;
a weight supported within the base for maintaining the outer shell in an upright position;
a controller supported within the internal chamber;
a memory supported within the internal chamber and operably coupled to the controller, the memory configured to store a first phrase in both a native language and a foreign language;
a speaker supported within the internal chamber and operably coupled to the controller;
a user interface is operably coupled to the controller and is configured to cause the controller to transmit audio output from the speaker in response to a user input; and
a power source supported within the internal chamber and operably coupled to the controller;
wherein the outer surface of the outer shell includes visual indicia representative of the foreign language stored in memory.

2. The language training device of claim 1, wherein the user interface comprises a motion sensor to detect movement of the outer shell.

3. The language training device of claim 2, wherein the motion sensor comprises a gravity switch.

4. The language training device of claim 1, wherein the controller causes the speaker to transmit audio output of the first phrase in the foreign language followed by audio output of the first phrase in the native language.

5. The language training device of claim 1, wherein the native language comprises English, and the foreign language comprises at least one of Arabic, Chinese, French, German, Portuguese and Spanish.

6. The language training device of claim 1, wherein the indicia comprises an animal associated with a country of the foreign language.

7. The language training device of claim 1, wherein the power source comprises a battery in electrical communication with the controller.

8. A language training device comprising:
an egg-shaped outer shell defining an internal chamber, and including a base and an upper portion extending upwardly from the base, the base having a semi-spherical outer surface;
a weight supported within the base for maintaining the outer shell in an upright position;
a controller supported within the internal chamber;
a memory supported within the internal chamber and operably coupled to the controller, the memory configured to store a first phrase in both a native language and a foreign language;
a speaker supported within the internal chamber and operably coupled to the controller;
a motion sensor operably coupled to the controller, the motion sensor configured to cause the controller to transmit audio output from the speaker in response to movement of the outer shell; and
a power source operably coupled to the controller.

9. The language training device of claim 8, wherein the outer surface of the outer shell includes visual indicia representative of the foreign language stored in memory.

10. The language training device of claim 9, wherein the indicia comprises an animal associated with a country of the foreign language.

11. The language training device of claim 8, wherein the motion sensor comprises a gravity switch.

12. The language training device of claim 8, wherein the controller causes the speaker to transmit audio output of the first phrase in the foreign language followed by the native language.

13. The language training device of claim 8, wherein the native language comprises English, and the foreign language comprises at least one of Arabic, Chinese, French, German, Portuguese and Spanish.

14. The language training device of claim 8, wherein the power source comprises a battery supported in the internal chamber and in electrical communication with the controller.

15. A method of teaching a foreign language comprising the steps of:
providing an egg-shaped outer shell defining an internal chamber, and including a base and an upper portion extending upwardly from the base, the base having a semi-spherical outer surface;
rocking the outer shell about the base;
transmitting an audible phrase in a foreign language; and
transmitting the audible phrase in a native language.

16. The method of claim 15, wherein the outer surface of the outer shell includes indicia representative of the foreign language.

17. The method of claim 16, wherein the indicia comprises an animal associated with a country of the foreign language.

18. The method of claim 15, wherein the step of rocking the outer shell includes activating a motion sensor.

19. The method of claim 15, wherein the audible phrase is stored in a memory.
